(19) United States
(12) Patent Application Publication
(10) Pub. No.: US 2025/0272946 A1
(43) Pub. Date: Aug. 28, 2025

(54) SENSOR FUSION FOR THIN FILM SEGMENTATION

(71) Applicant: Carl Zeiss SMT GmbH, Oberkochen (DE)

(72) Inventors: Dmitry KLOCHKOV, Schwaebisch Gmuend (DE); Abhilash SRIKANTHA, Neu-Ulm (DE); Eugen FOCA, Ellwangen (DE); Ramani PICHUMANI, Palo Alto, CA (US); Thomas KORB, Schwaebisch Gmuend (DE); Keumsil LEE, Palo Alto, CA (US)

(21) Appl. No.: 19/200,274

(22) Filed: May 6, 2025

Related U.S. Application Data
(63) Continuation of application No. PCT/EP2023/081030, filed on Nov. 7, 2023.
(60) Provisional application No. 63/424,233, filed on Nov. 10, 2022.
(60) Provisional application No. 63/423,962, filed on Nov. 9, 2022.

(51) Int. Cl. G06V 10/26; G06T 7/60; G06V 10/774; G06V 10/80

(52) U.S. Cl. CPC G06V 10/26; G06T 7/60; G06V 10/774; G06V 10/809; G06T 2207/10061; G06T 2207/20081; G06T 2207/30148

(57) ABSTRACT

Certain examples provide methods of performing semiconductor metrology by analyzing a sample surface, wherein the methods comprise: obtaining a first image generated using a first image modality; obtaining a second image generated using a second image modality; generating first labels by segmenting the first image; generating second labels by segmenting the second image; and generating third labels associated with the first image and the second image by fusing the first labels and the second labels.

### CROSS-REFERENCE TO RELATED APPLICATIONS

The present application is a continuation of, and claims benefit under 35 USC 120 to, international application No. PCT/EP2023/081030, filed Nov. 7, 2023, which claims which claims the benefit of priority of U.S. Provisional Appl. No. 63/424,233, filed Nov. 10, 2022, and U.S. Provisional Appl No. 63/423,962, filed Nov. 9, 2022. The entire disclosure of each of these applications is incorporated by reference herein.

### FIELD

The disclosure generally relates to performing semiconductor metrology by analyzing sample surfaces.

### BACKGROUND

Manufacturing of semiconductor devices relies on the precise identification of semiconductor structures and their properties. With decreasing feature sizes, scanning electron microscopes (SEM) are becoming more and more important to identify features of manufactured semiconductor structures, for example to determine parameters including at least one of form, size and position of the features.

An SEM scans a surface of a sample with a beam of primary electrons. These primary electrons release a full spectrum of scattering products from the sample surface which may be partitioned based on energy and takeoff angle into different detectors including, e.g., at least one of an in-lens secondary electron (SE) detectors, an in-lens backscatter electron (BSE) detector, an external SE detector, an x-ray detector.

Not all features of a semiconductor structure to be monitored may be observable with every detector. Further, even minute deviations from desired structures and properties in a process step of a semiconductor device production line may lead to a drop of the overall yield. In general, it is desirable to reveal process deviations early on in the production line.

### SUMMARY

The disclosure seeks to provide methods facilitating the detection of semiconductor structures and properties.

Examples of the disclosure provide a method of performing semiconductor metrology by analyzing a sample surface, the method comprising: obtaining a first image of the sample surface having been generated using a first image modality; obtaining a second image of the sample surface having been generated using a second image modality generating a third image by performing a non-linear fusion of the first image and the second image generating third labels associated with the sample surface by segmenting the third image.

Further examples of the disclosure provide a method of performing semiconductor metrology by analyzing a sample surface, the method comprising: obtaining a first image having been generated using a first image modality; obtaining a second image having been generated using a second image modality; generating first labels by segmenting the first image; generating second labels by segmenting the second image; and generating third labels associated with the first image and the second image by fusing the first labels and the second labels.

Some examples of the disclosure provide a method of performing semiconductor metrology by analyzing a sample surface, the method comprising: obtaining a first image having been generated using a first image modality; obtaining a second image having been generated using a second image modality; generating third labels associated with the first image and the second image by processing the first image and a second image in a trained machine learning logic.

Additional examples of the disclosure relate to a method of training a machine learning logic for performing semiconductor metrology by analyzing a sample surface. The method can comprise obtaining training sets comprising a first training image of a sample surface having been generated using a first image modality and a second training image of a sample surface having been generated using a second image modality; obtaining, for each training set of the training sets, a third annotation; processing the sets of the first training image and the second training image in a machine-learning logic; obtaining from the machine-learning logic, for each set of the first training image and the second training image, a third label; and performing the training of the machine-learning logic by updating parameter values of the machine-learning logic based on a comparison of the third label and the third annotation.

The disclosure provides a computer program or a computer-program product or a computer-readable storage medium that includes program code. The program code can be loaded and executed by at least one processor. Upon executing the program code, the at least one processor can perform a method according to the disclosure.

A processing device is disclosed. The processing device can include a processor and a memory, the processor being configured to load program code from the memory and execute the program code. The processor, upon executing the program code, is configured to perform a method as described above.

It is to be understood that the features mentioned above and those yet to be explained below may be used not only in the respective combinations indicated, but also in other combinations or in isolation.

### BRIEF DESCRIPTION OF THE DRAWINGS

FIG. 1 schematically illustrates a scanning electron microscope system;

FIG. 2 illustrates a vertical cross section of a semiconductor structure;

FIG. 3 illustrates a top down cross section of a semiconductor structure;

FIG. 4 illustrates differences between image modalities;

FIG. 5 illustrates a method of analyzing a sample surface;

FIG. 6 further illustrates the method of analyzing a sample surface of FIG. 5;

FIG. 7 illustrates a method of analyzing a sample surface;

FIG. 8 further illustrates the method of analyzing a sample surface of FIG. 7;

FIG. 9 illustrates a method of analyzing a sample surface;

FIG. 10 further illustrates the method of analyzing the sample surface of FIG. 9;

FIG. 11 illustrates a method of training a machine-learning logic;

FIG. 12 illustrates a method of training a machine learning logic; and

FIG. 13 illustrates a method of training a machine learning logic.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the disclosure will be described in detail with reference to the accompanying drawings. It is to be understood that the following description of embodiments is not to be taken in a limiting sense. The scope of the disclosure is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. Functional blocks may be implemented in hardware, firmware, software, or a combination thereof.

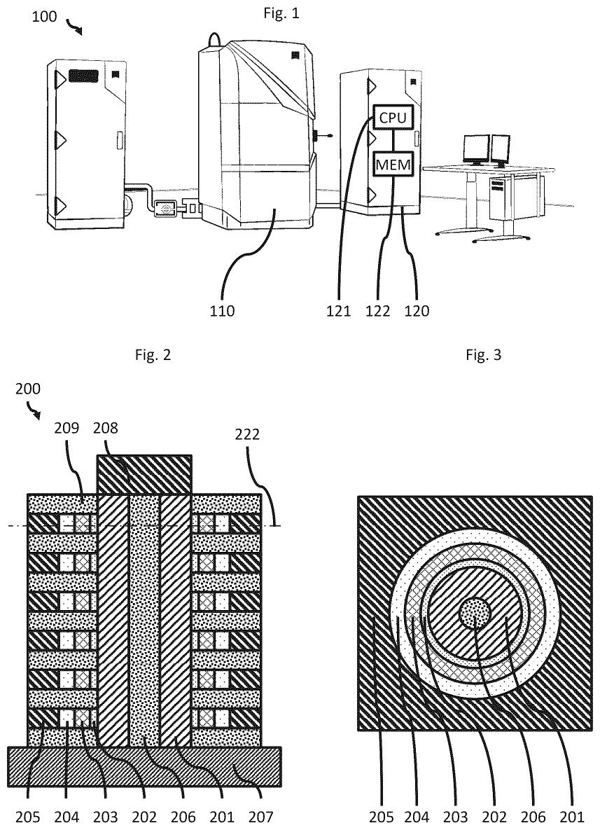

FIG. 1 illustrates a system 100 for analyzing sample surfaces. The system 100 comprises a SEM 110 for acquiring images of the sample surface using one or more image modalities and a processing device 120 including a processor 121 and a memory 122. The processor 121 may be configured to load program code from the memory and execute the program code, wherein the processor, upon executing the program code, is configured to perform one of the methods of analyzing a sample surface as set forth below.

The SEM 110 may acquire images by scanning the sample surface with a primary electron beam and detecting scattering products with one or more detectors. The detectors may include at least one of an in-lens secondary electron detector (in-lens SE detector), an in-lens backscatter secondary electron (BSE) detector (in-lens BSE detector), an external secondary electron detector (external SE detector), an external BSE detector and an X-ray detector. Obtaining an image using a specific image modality may refer to acquiring an image using one of the detectors. For each position of the primary electron beam the corresponding signal of the selected detector may be acquired. Typically different channels are associated with the different detectors. Hence, acquiring an image using a specific image modality may also be referred to as acquiring an image using a specific channel (or detector channel).

In some scenarios, the SEM 110 may co-acquire a first image using a first image modality and a second image using a second image modality. For example, the SEM 110 may scan the sample surface with the primary electron beam and acquire the signals from a first detector and a second detector in parallel. Co-acquiring the first image using the first image modality and the second image using the second image modality may result in the first image and the second image naturally being registered with respect to each other. Thus, an additional registration step may be omitted. This may reduce the processing time and energy. Moreover, noise induced by registration may be avoided.

The SEM 110 may use a single primary electron beam or a plurality of primary electron beams for acquiring images. An SEM 110 using a plurality of primary electron beams may also be called MultiSEM or mSEM. Using a plurality of primary electron beams may allow for scanning a larger area of the surface sample in a given time.

Various kinds and types of semiconductor structures and properties may have to be analyzed. For instance, a three-dimensional (3-D) memory chip may be analyzed, e.g., a vertical NAND (3D NAND) memory chip or a 3-D DRAM chip. 3-D memory chips (3D NAND or 3D RAM) are composed of many pillar-like structures running parallel to each other and sometimes referred to as memory channels or “pillars”. Deep-etched memory channel holes crossing multiple layers, e.g., different conducting (e.g., metallization) layers or isolation layers.

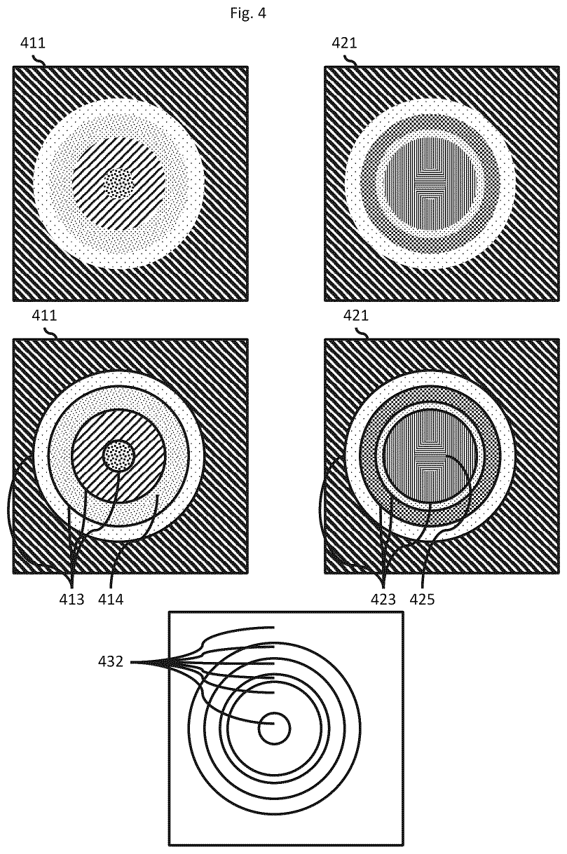

FIGS. 2 and 3 schematically illustrate a 3D NAND memory structure 200. FIG. 3 shows a cross-section of the 3D NAND memory structure 200 along the line 222 shown in FIG. 2. The 3D NAND cell 200 includes an active portion 201 connecting a bit line 208 of the 3D NAND 200 to the substrate 207. The bit line 208 may be made of a metal material, e.g., tungsten (W), the active portion 201 is made of a semi-conductor material, e.g., poly-Si, and the substrate 208 may be a Si-substrate. The active portion 201 may be hollow and filled with a filler 206. The filler 206 may be made of SiO₂. The active portion 201 is surrounded by a first dielectric layer 202, a floating gate or charge trap layer 203, a second dielectric layer 204, and a gate or word line 205. Several cells of the 3D NAND memory structure 200 may be separated from each other by an inter-layer dielectric 209. The inter-layer dielectric may be made of SiO₂. A conductive channel may be formed in the active portion 201 connecting the bit line 208 of the 3D NAND 200 to the substrate 207 depending on a voltage level of the charge trap layer 203 and the gate or word line 205.

The first dielectric layer 202 may also be called tunneling oxide. Upon application of a sufficient voltage between the gate 205 and the active portion 201, electrons may tunnel through the first dielectric layer 202 and may be trapped in the floating gate or charge trap layer 203. The first dielectric layer 202 may be made of SiO₂. The layer 203 may be a charge trap layer made of Si₃N₄. The second dielectric layer 204 may insulate the layer 203 from the gate 205. The second dielectric layer 204 may be made of blocking oxide. For example, the second dielectric layer 204 may be made of Al₂O₃. The gate 205 may be made of tungsten.

During semiconductor device production, deviations of a manufactured semiconductor structure from a desired semiconductor structure may have to be determined. For example, slice-and-image tomographic techniques may be used to generate a 3D image of the manufactured semiconductor structure. Heretofore, a dual-beam device may be used. In a dual-beam device, two particle optical systems are arranged at an angle (column offset angle). The two particle optical systems may be oriented perpendicularly or at a column offset angle between 45° and 90°. The first particle optical system defines an imaging column. The imaging column may be implemented by a SEM or a helium-ion microscope (HIM). The second particle optical system defines a milling column. The milling column may be a focused ion beam (FIB) optical system, using for example Gallium (Ga) ions. The FIB of Ga is used to cut off slices of a test volume of the sample, slice-by-slice. Thereby, images depicting cross-sections of the sample are obtained at different milling depths using the imaging column.

For comparing the manufactured semiconductor structure with a desired semiconductor structure, the features of the manufactured semiconductor structure are identified in the image.

Depending on the image modality used for acquiring the images, features of the manufactured semiconductor structure may be easier or more difficult to identify or not identifiable at all.

Images described herein may refer to two-dimensional images (2D-images) of a sample and/or three-dimensional images (3D-images) of a sample. 3D-images may be obtained by performing tomographic techniques, for example. Likewise methods of analyzing a sample surface comprise methods of analyzing surface volume of a sample.

FIG. 4 schematically illustrates a first image 411 depicting a cross-section of a manufactured semiconductor structure having been acquired using a first image modality and a second image 421 depicting the same cross-section having been acquired using a second image modality. The manufactured semiconductor structure may have to be compared with the desired semiconductor structure shown in FIG. 2 or 3.

The interfaces 413 between filler and the channel, between the channel and the first dielectric layer, between the charge trap layer and the second dielectric layer, and between the second dielectric layer and the gate may be easy to identify in the first image 411. However, the interface 414 between the first dielectric layer and the charge trap layer may be hardly recognizable, all.

With respect to the second image 421, the interfaces 423 between the channel and the first dielectric layer, between the first dielectric layer and the charge trap layer, between the charge trap layer and the second dielectric layer, and between the second dielectric layer and the gate may be facile to detect. However, the interface 425 between the filler and the channel may be nearly invisible.

Examples described herein envisage to improve usage of information provided by different image modalities to provide features, e.g. regions, of a sample surface with third labels 432. The third labels may then be used to determine deviations of the manufactured semiconductor structure from a desired semiconductor structure. For example, a lateral offset of the manufactured semiconductor structure according to FIG. 4 and the desired semiconductor structure according to FIG. 3 may be determined. In other examples, a thickness deviation of one of the dielectric layers may be determined. Further examples may prescribe identifying a deviation from the desired form, e.g., an elliptic form instead of a cylindrical form.

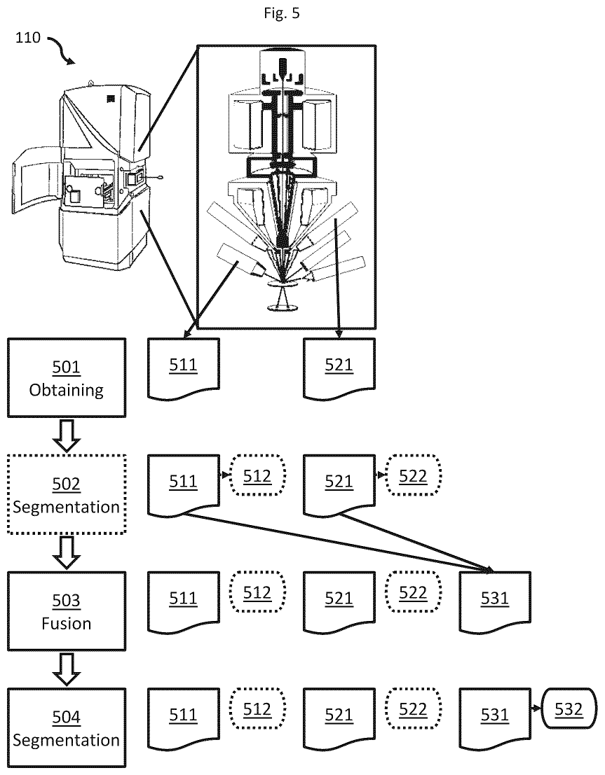

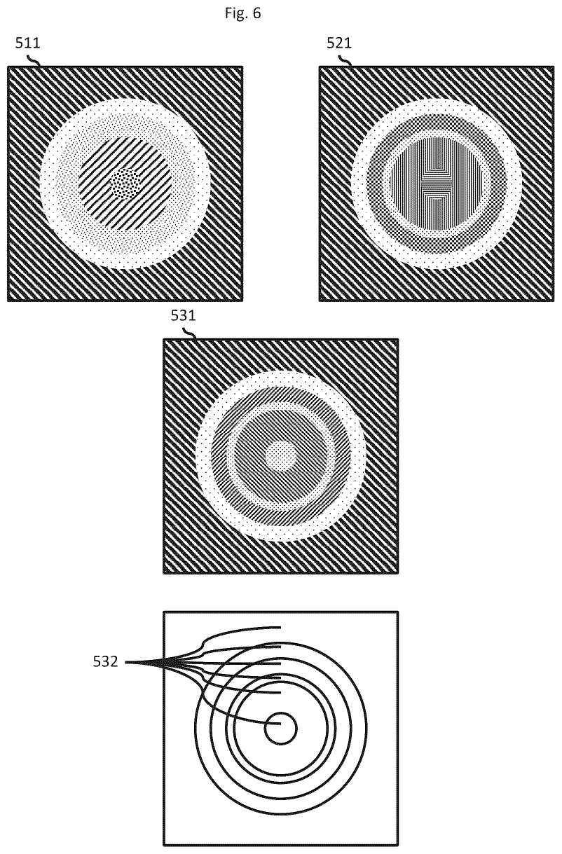

FIGS. 5 and 6 illustrate an example of analyzing a sample surface, wherein optional method features are depicted with dashed lines. At 501, the method prescribes obtaining a first image 511 of the sample surface having been generated using a first image modality and obtaining a second image 521 of the sample surface having been generated using a second image modality. FIG. 6 schematically shows an example of the first image 511 and the second image 521. The first image modality is different from the second image modality. For example, the first image 511 may have been acquired with a different detector than the second image 521. Further, the first image 511 may have been acquired with the same detector using a different detector setting than the second image 521. In some examples, the first image 511 and the second image 521 may be registered with each other. The first image 511 and/or the second image 521 may be obtained from a data storage. For example, the first image 511 and/or the second image 521 may be obtained from the memory 122 of the processing device 120. Obtaining the first image 511 and/or the second image 521 may also comprise acquiring the first image 511 and/or the second image 521 with an imaging device. For example, obtaining the first image 511 using the first image modality and/or obtaining the second image 521 using the second image modality comprises performing scanning electron microscopy, for example multiple beam scanning electron microscopy 110. This may involve using at least one of an in-lens secondary electron detector, an in-lens backscatter secondary electron detector, an external secondary electron detector, external backscatter detector, and an X-ray detector.

Optionally, segmentation 502 of the first image 511 and the second image 521 may be performed to obtain first labels 512 for the first image 511 and second labels 522 for the second image 521. In some scenarios, segmentation of the first image 511 and the second image 521 involve machine learning techniques. Other scenarios may prescribe performing segmentation of the first image 511 and the second image 521 using classic image processing techniques.

A third image 531 may be generated by performing a non-linear fusion of the first image 511 and the second image 521. Non-linear fusion of the first image 511 and the second image 521 may comprise to set the value of each pixel of the third image 531 to the maximum of the value of the corresponding pixel of the first image 511 and the value of the corresponding pixel of the second image 512. Non-linear fusion of the first image 511 and the second image 521 may also comprise to set the value of each pixel of the third image 531 to the product of the value of the corresponding pixel of the first image 511 and the value of the corresponding pixel of the second image 512. Some examples may prescribe that different weights may be attributed to the values of the pixels of the first image 511 and the values of the pixels of the second image before performing the non-linear fusion.

Segmentation 504 of the third image 531 is performed to obtain third labels 532. In some scenarios, segmentation may involve machine learning techniques. Other scenarios may prescribe performing segmentation using classic image processing techniques.

As schematically illustrated in FIG. 6, the third image 531 may comprise more information allowing for a better segmentation. For example, the interfaces between different regions may be more pronounced facilitating segmentation. Thus, segmentation may result in third labels 532 being more suitable for determining parameters of features of the actual sample.

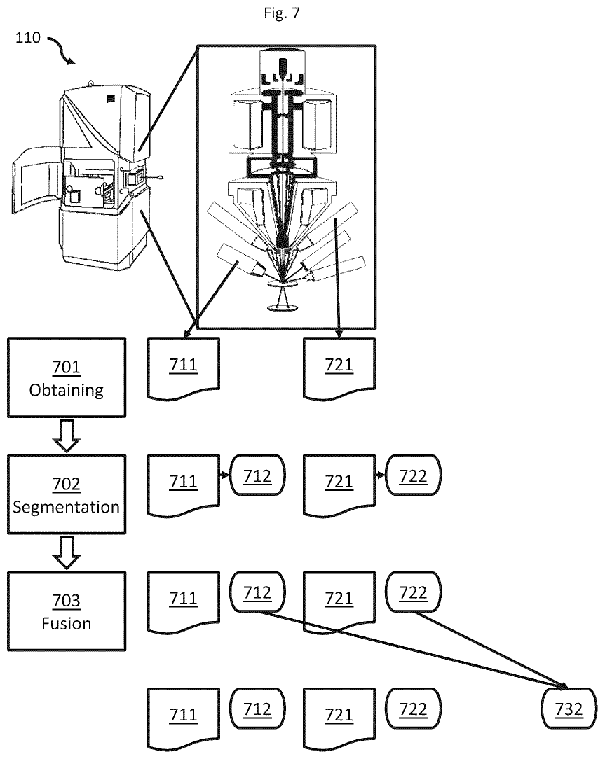

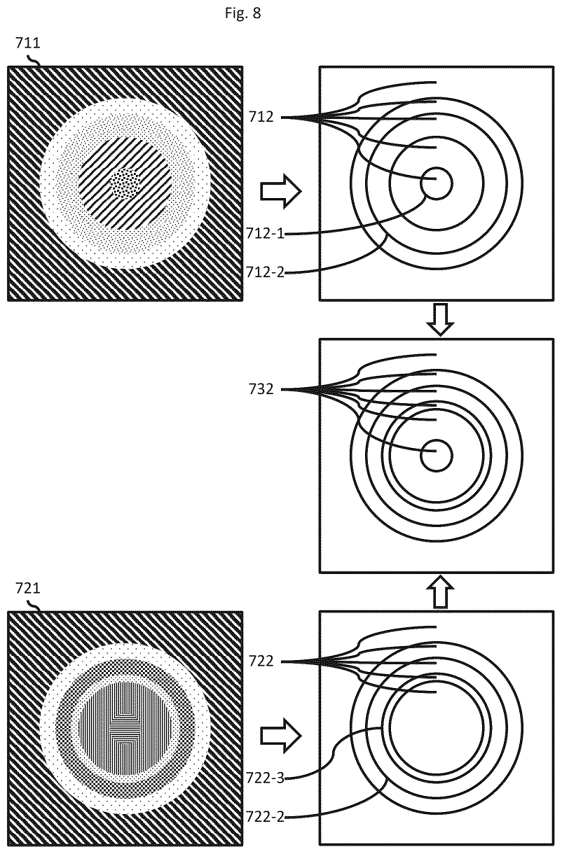

FIGS. 7 and 8 illustrate another example of analyzing a sample surface. Analyzing the sample surface starts with obtaining 701 a first image 711 of the sample surface having been generated using a first image modality and obtaining a second image 721 of the sample surface having been generated using a second image modality. An example of the first image 711 and the second image 721 is shown for illustration purposes in FIG. 8.

The first image modality is different from the second image modality. The first image 711 may have been acquired with a different detector than the second image 721. It is also perceivable that the first image 711 and the second image 721 have been acquired with the same detector but different detector settings. Optionally, the first image 711 and the second image 721 may be registered with each other. The first image 711 and/or the second image 721 may be obtained from a data storage. For example, the first image 711 and/or the second image 721 may be obtained from the memory 122 of the processing device 120.

Obtaining the first image 711 and/or the second image 721 may comprise acquiring the first image 711 and/or the second image 721 with an imaging device, too. For example, obtaining the first image 711 using the first image modality and/or obtaining the second image 721 using the second image modality comprises performing scanning electron microscopy, for example multiple beam scanning electron microscopy 110. This may involve using at least one of an in-lens secondary electron detector, an in-lens backscatter secondary electron detector, an external secondary electron detector, an external backscattered secondary electron (BSE) detector, external backscatter detector and an X-ray detector.

At 702, segmentation of the first image 711 and segmentation the second image 721 may be performed to obtain first labels 712 for the first image 711 and second labels 722 for the second image 721. Segmentation of the first image 711 and the second image 721 may involve machine learning techniques. However, segmentation of the first image 711 and the second image 721 may also be performed using classic image processing techniques.

Third labels 732 are generated from the first labels 712 and the second labels 722 at 703. The first labels 712 and the second labels 722 may be fused or merged to obtain the third labels 732. For example, a processing device may identify that an interface 712-2 between regions identified by two first labels 712 corresponds to an interface 722-2 between regions identified by two second labels 722. Detected minor difference between the location of the interface 712-2 and the interface 722-2 may be used to improve the segmenting of the first image 711 and the segmenting of the second image 712. Moreover, the processing device may device may determine that the interface 712-1 has not been detected upon segmenting the second image 721 and that the interface 722-3 has been detected upon segmenting the first image 711.

In some examples, a confidence may be attributed to the third labels 732. The confidence may indicate a level of certainty that the third label correctly identifies a feature of a detected semiconductor structure. In some examples, a confidence may be provided for the first labels 712 and the second labels 722. For example, a machine-learning logic used for obtaining the first labels 712 and the second labels 722 may provide a respective confidence. The confidence of the third labels 732 may be the product of the individual confidences. In examples, there a transition regions where segmentation of the first image 711 and the segmentation of the second image 721 behave differently leading to confusing third labels which could be assigned to known third labels with reduced confidence.

Generating third labels 732 associated with the first image 711 and the second image 721 by fusing the first labels 712 and the second labels 722 may comprise performing for each pixel a logic operation on the corresponding pixel of the first label 712 and the corresponding pixel of the second label 722.

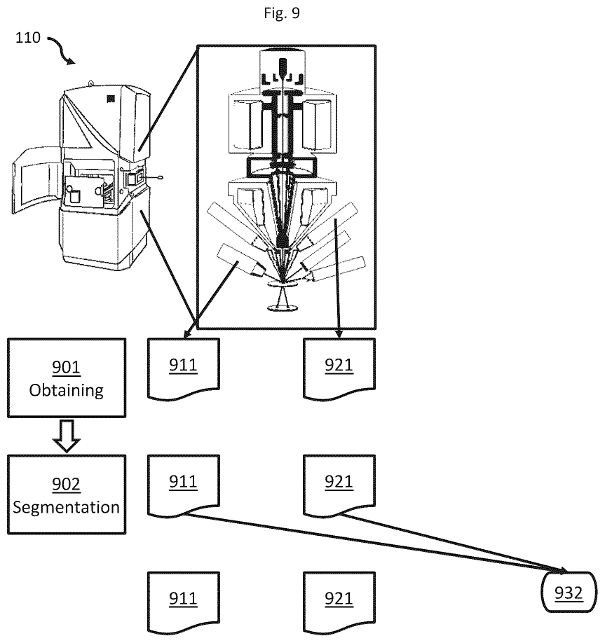

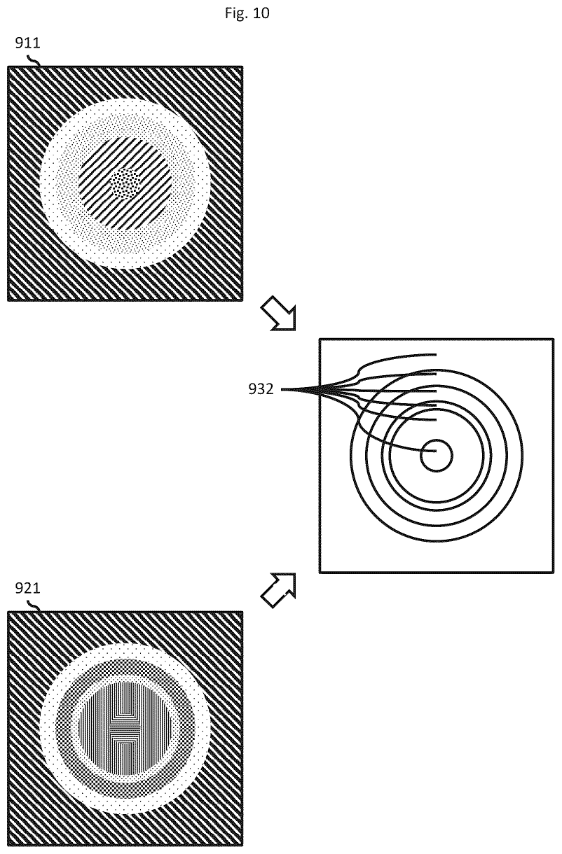

FIGS. 9 and 10 illustrate a still further method of analyzing a sample surface. At 901, a first image 911 of the sample surface having been generated using a first image modality and a second image 921 of the sample surface having been generated using a second image modality are obtained. FIG. 9 shows an example of the first image 911 and the second image 921.

The first image modality and the second image modality differ. The first image 911 may have been acquired with a different detector than the second image 921. It is also perceivable that the first image 911 and the second image 921 have been acquired with the same detector but different detector settings. In some examples, the first image 911 and the second image 921 may be registered with each other. The first image 911 and/or the second image 921 may be obtained from a data storage. For example, the first image 911 and/or the second image 921 may be obtained from the memory 122 of the processing device 120.

Obtaining the first image 911 and/or the second image 921 may comprise acquiring the first image 911 and/or the second image 921 with an imaging device, too. For example, obtaining the first image 911 using the first image modality and/or obtaining the second image 921 using the second image modality comprises performing scanning electron microscopy, for example multiple beam scanning electron microscopy 110. This may involve using at least one of an in-lens secondary electron detector, an in-lens backscatter secondary electron detector, an external secondary electron detector, an external backscattered secondary electron (BSE) detector, an external backscatter detector, and an X-ray detector.

Instead of performing, separately, a segmentation of the first image 911 for obtaining first labels and a segmentation of the second image 921 for obtaining second labels followed by a fusion of first labels and second to obtain third labels, the first image 911 and the second image 912 may be processed jointly in a trained machine learning logic to obtain the third labels 932. The trained machine learning logic may be implemented by a processing device.

Examples have been described herein with respect to first images having been generated using a first image modality and second image having been generated using a second image modality. In some scenarios, more than two different image modalities may be used to further improve the analysis of the sample surface.

Irrespective of the method used, the third labels may be used to determine parameters of features of the sample surface. With respect to a semiconductor structure, it may be possible that the third labels are indicative of the material in a certain region. For example, the third labels may be indicative of the chemical composition in the respective region. In other examples, the third labels may be indicative of the solid state modification (e.g., polycrystalline, monocrystalline, crystal orientation, polymorph, crystallographic modification).

The third labels may be used to determine features and/or geometric properties of the regions. For example, the third labels may allow for comparing a manufactured semiconductor structure to a desired semiconductor structure.

According to examples, a sample surface to be analyzing according to one of the methods described above may be a semiconductor structure sample surface or a surface of an exposure mask for manufacturing a semiconductor structure.

Examples of the method may prescribe identifying, based at least on the third labels, a feature of the semiconductor structure. A feature may comprise at least one of a polygon, a rectangle, a triangle, an ellipse, a circle, and a ring. Some examples may prescribe identifying at least one geometric property of a feature of the semiconductor structure. The geometric property may comprise at least one of a thickness of the feature of the semiconductor structure, a position of the feature of the semiconductor structure, a diameter of the feature of the semiconductor structure, a center of the feature of the semiconductor structure, an eccentricity of the feature of the semiconductor structure.

Based on the analyzed semiconductor structure sample surface, a variation of a manufactured semiconductor structure from a desired semiconductor structure may be identified.

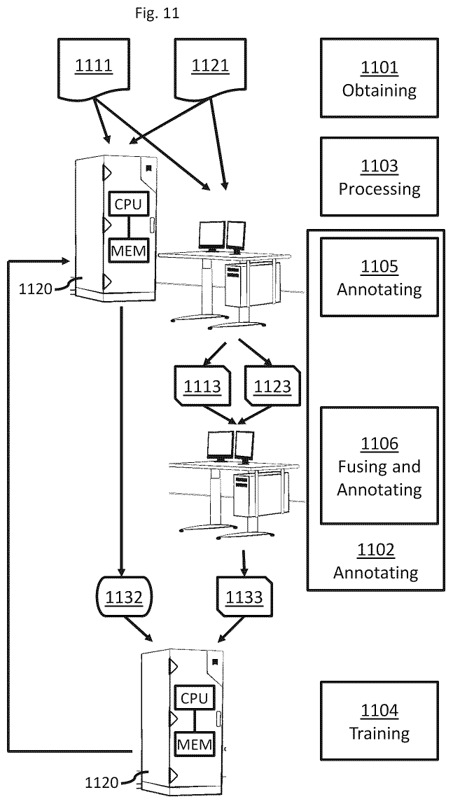

FIG. 11 illustrates a method of training a machine learning logic for performing semiconductor metrology by analyzing a sample surface. At 1101, the method prescribes obtaining training sets comprising a first training image 1111 of a sample surface having been generated using a first image modality and a second training image 1121 of the sample surface having been generated using a second image modality.

For each training set of the training sets, a third annotation 1133 is obtained (Box 1102). Annotating may refer to providing labels manually. For example, annotating may refer to adding expert knowledge. Annotating may refer to manually identifying semiconductor structures. In some examples, there may be a finite number of values for the third label. For example, there may be a limited number of features of which the semiconductor structure consists. For example, there may be a limited number of materials of which the semiconductor structure consists. The features of which the semiconductor structure consists may be known to the person providing the third annotation.

The sets of the first training images and second training images are processed in a machine-learning logic 1120 to obtain from the machine-learning logic 1120 for each set of a first training image 1111 and a second training image 1121, a third label 1132.

At 1104, the training 1104 of the machine-learning logic 1120 is performed by updating parameter values of the machine-learning logic 1120 based on a comparison of the third label 1132 and the third annotation 1133.

Obtaining (1102), for each training set of the training sets, a third annotation 1133 may comprise: obtaining (1105), for each training set, for the first training image 1111 a first label 1113 and for the second training image 1121 a second label 1123 and obtaining the third annotation 1133 by performing a fusion and annotating operation 1106 on the first label and the second label 1123.

The first label 1113 may be a first annotation 1113 and the second label 1123 may be a second annotation 1123. Thus, the first label 1113 and the second label 1123 may be added manually.

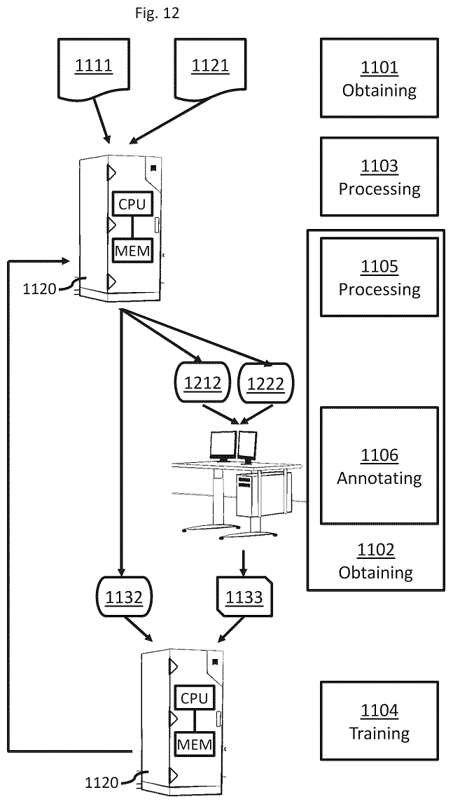

However, as shown in FIG. 12, it is also conceivable that the first label 1112 and the second label 1122 are generated automatically by processing the first training image 1111 and the second training image 1121. For example, a trained machine learning logic may be used for that purpose.

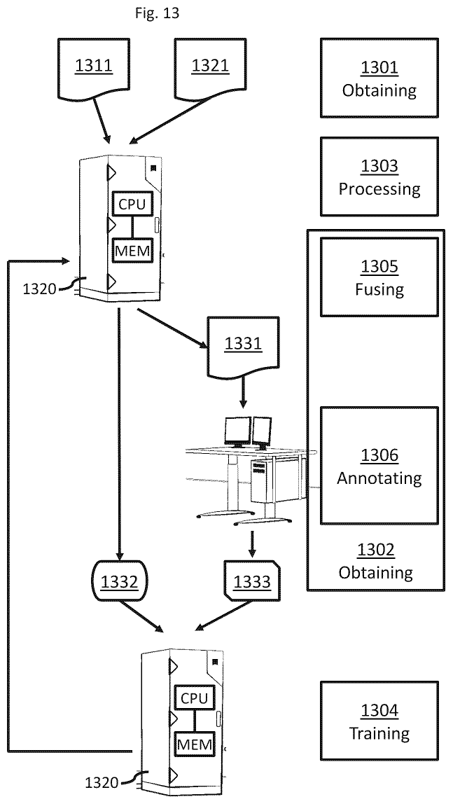

FIG. 13 illustrates a further method of training a machine-learning logic for performing semiconductor metrology by analyzing a sample surface. The method comprises obtaining (1301) training sets each comprising a first training image 1311 of a sample surface having been generated using a first image modality and a second training image 1321 of the sample surface having been generated using a second image modality. For each training set of the training sets, a third annotation 1333 is obtained.

Heretofore, fusion (1305), for example a non-linear fusion, of the first training image 1311 and the second training image 1321 to obtain a third training image 1331 is performed. The non-linear fusion of the first training image 1311 and the second training image 1321 may be performed using a method described above with respect to the non-linear fusion of a first image and a second image. Afterwards, annotating (1306) of the third training image 1331 may be performed to obtain the third annotation 1333.

From a machine-learning logic 1320, for each set of a first training image 1311 and a second training image 1321, a third label 1332 may be obtained at 1303 and the machine-learning logic 1320 may be trained by updating parameter values of the machine-learning logic 1320 based on a comparison of the third label and the third annotation.

Although the disclosure has been shown and described with respect to certain embodiments, equivalents and modifications will occur to others skilled in the art upon the reading and understanding of the specification. The present disclosure includes all such equivalents and modifications and is limited only by the scope of the appended claims.

1. A method, comprising:
obtaining a first image of a surface of a semiconductor sample generated using a first image modality;
obtaining a second image of the surface of the semiconductor sample generated using a second image modality;
generating first labels by segmenting the first image;
generating second labels by segmenting the second image; and
generating third labels associated with the first and second images by fusing the first and second labels.

2. The method of claim 1, wherein generating the third labels comprises identifying corresponding first and second labels.

3. The method of claim 1, wherein generating the third labels comprises attributing a confidence to the third labels.

4. The method of claim 1, wherein, for each pixel, generating the third labels comprises performing a logic operation on the pixel of the first label and the pixel of the second label.

5. The method of claim 1, wherein the sample surface comprises a member selected from the group consisting of a semiconductor structure sample surface and a surface of an exposure mask for manufacturing a semiconductor structure.

6. The method of claim 5, further comprising identifying, based at least on the third labels, a feature of the semiconductor structure.

7. The method of claim 6, wherein the feature of the semiconductor structure comprises at least one of member selected from the group consisting of a polygon, a rectangle, a triangle, an ellipse, a circle, and a ring.

8. The method of claim 6, further comprising identifying a geometric property of the feature of the semiconductor structure.

9. The method of claim 8, wherein the geometric property comprises at least one member selected from the group consisting of a thickness of the feature of the semiconductor structure, a position of the feature of the semiconductor structure, a diameter of the feature of the semiconductor structure, a center of the feature of the semiconductor structure, and an eccentricity of the feature of the semiconductor structure.

10. The method of claim 6, further comprising identifying a variation of a manufactured semiconductor structure from a desired semiconductor structure based on the semiconductor structure sample surface.

11. The method of claim 1, wherein obtaining the first image using the first image modality and/or obtaining the second image using the second image modality comprises performing scanning electron microscopy.

12. One or more machine-readable hardware storage devices comprising instructions that re executable by one or more processing device to perform operations comprising the method of claim 1.

13. A system, comprising:
one or more processing devices; and
one or more machine-readable hardware storage devices comprising instructions that re executable by one or more processing device to perform operations comprising the method of claim 1.

14. A method, comprising:
obtaining a first image of a surface of a semiconductor sample generated using a first image modality;
obtaining a second image of the surface of the semiconductor sample generated using a second image modality;
generating a third image by performing a non-linear fusion of the first and second images; and
generating third labels associated with the sample surface by segmenting the third image.

15. The method of claim 14, wherein performing the non-linear fusion comprises setting a value of a pixel of the third image to a maximum of a value of a corresponding pixel of the first image and a value of a corresponding pixel of the second image.

16. The method of claim 14, wherein performing the non-linear fusion comprises setting a value of a pixel of the third image to a product of a value of a corresponding pixel of the first image and a value of a corresponding pixel of the second image.

17. The method of claim 14, wherein performing the non-linear fusion comprises setting a value of a pixel of the third image to a quotient of a value of a corresponding pixel of the first image and a non-zero value of a corresponding pixel of the second image.

18. The method of claim 14, further comprising attributing a weight to at least one member selected from the group consisting of values of pixels of the first image and values of pixels of the second image.

19. The method of claim 14, wherein the sample surface comprises a member selected from the group consisting of a semiconductor structure sample surface and a surface of an exposure mask for manufacturing a semiconductor structure.

20.-22. (canceled)

23. A method, comprising:
obtaining training sets, each training set comprising:
a first training image of a surface of a semiconductor sample surface generated using a first image modality; and
a second training image of the surface of the semiconductor sample generated using a second image modality;
for each training set, obtaining a third annotation;
processing the training sets in a machine-learning logic;
for each training set, obtaining from the machine-learning logic a third label; and
training the machine-learning logic by updating parameter values of the machine-learning logic based on a comparison of the third label and the third annotation.

24.-28. (canceled)
